(19) United States
(12) Patent Application Publication
(10) Pub. No.: US 2020/0094983 A1
(43) Pub. Date: Mar. 26, 2020

(54) INTAKE DUCT DESIGNING METHOD, COMPUTER READABLE MEDIUM, AND INTAKE DUCT DESIGNING APPARATUS

(71) Applicant: SUBARU CORPORATION, Tokyo (JP)

(72) Inventors: Tomoyuki OKITA, Tokyo (JP); Takeshi OSUKA, Tokyo (JP)

(21) Appl. No.: 16/435,112

(22) Filed: Jun. 7, 2019

(30) Foreign Application Priority Data
Sep. 21, 2018 (JP) 2018-176884

(51) Int. Cl. B64D 33/02; F02C 7/04

(52) U.S. Cl. CPC B64D 33/02; F02C 7/04

(57) ABSTRACT

An intake duct designing method includes: setting a value of a design parameter concerning a design target directed to an aircraft intake duct including a bypass mechanism that suppresses an aerial vibration phenomenon; setting a shape of the design target using the design parameter value; performing computational fluid dynamics analysis including calculating aerodynamic characteristics of the design target and a necessary bypassing flow rate of air released through the bypass mechanism for suppressing the aerial vibration phenomenon, by creating an analytical model for the analysis using the shape of the design target; determining whether an analysis result satisfies a preset design condition; updating the design parameter value when the analysis result is determined as not satisfying the design condition; and repeating the shape setting, the computational fluid dynamics analysis, the determining, and the design parameter value updating, until the analysis result is determined as satisfying the design condition.

### CROSS-REFERENCE TO RELATED APPLICATIONS

The present application claims priority from Japanese Patent Application No. 2018-176884 filed on Sep. 21, 2018, the entire contents of which are hereby incorporated by reference.

### BACKGROUND

The technology relates to a technique directed to designing of an intake duct having a bypass mechanism.

In all of operation states of an aircraft, an intake duct of the aircraft is required be able to supply air to an engine in a state where the engine operates normally, by capturing air having a flow rate required from the engine. Accordingly, the intake duct is required, as an aerodynamic requirement, to have a shape that does not generate total pressure loss and flow unevenness, i.e., flow distortion of an airflow that passes through.

Further, there is a possibility that an aircraft that flies at a supersonic speed may undergo an aerial vibration phenomenon, i.e., buzz inside the intake duct. For example, reference is made to Japanese Unexamined Patent Application Publication No. H10-30497. The buzz can cause non-operation of the engine as well as damage to the engine, thus making it necessary to provide the intake duct, of the aircraft that flies at the supersonic speed, with a mechanism that makes it possible to suppress the buzz. One example of the mechanism is a bypass mechanism. The buzz occurs when a flow rate of air falls below a certain lower limit. Hence, it is possible to favorably suppress the buzz by taking in air having a flow rate that allows for suppression of the buzz and by releasing air that is unnecessary for the engine, among the air that has been taken in. The air unnecessary for the engine is released out of the duct through the bypass mechanism.

### SUMMARY

An aspect of the technology provides an intake duct designing method that uses an intake duct designing apparatus. The method includes: setting a value of a design parameter concerning a design target on a basis of an input operation, in which the design target is directed to an intake duct of an aircraft and in which the intake duct includes a bypass mechanism that suppresses an aerial vibration phenomenon; setting a shape of the design target on the basis of the value of the design parameter; performing computational fluid dynamics analysis that includes calculating an aerodynamic characteristic of the design target and a necessary bypassing flow rate of air to be released through the bypass mechanism that suppresses the aerial vibration phenomenon, by creating an analytical model for the computational fluid dynamics analysis on the basis of the shape of the design target set in the setting of the shape; determining whether an analysis result in the performing of the computational fluid dynamics analysis satisfies a preset design condition; updating the value of the design parameter in a case where the analysis result in the performing of the computational fluid dynamics analysis is determined by the determining as not satisfying the design condition; and repeating the setting of the shape, the performing of the computational fluid dynamics analysis, the determining, and the updating of the value of the design parameter, until the analysis result in the performing of the computational fluid dynamics analysis is determined by the determining as satisfying the design condition.

An aspect of the technology provides a non-transitory computer readable medium containing an intake duct designing program. The intake duct designing program causes, when executed by a computer, the computer to implement a method. The method includes: setting a value of a design parameter concerning a design target on a basis of an input operation, in which the design target is directed to an intake duct of an aircraft and in which the intake duct includes a bypass mechanism that suppresses an aerial vibration phenomenon; setting a shape of the design target on the basis of the value of the design parameter; performing computational fluid dynamics analysis that includes calculating an aerodynamic characteristic of the design target and a necessary bypassing flow rate of air to be released through the bypass mechanism that suppresses the aerial vibration phenomenon, by creating an analytical model for the computational fluid dynamics analysis on the basis of the shape of the design target set in the setting of the shape; determining whether an analysis result in the performing of the computational fluid dynamics analysis satisfies a preset design condition; updating the value of the design parameter in a case where the analysis result in the performing of the computational fluid dynamics analysis is determined by the determining as not satisfying the design condition; and repeating the setting of the shape, the performing of the computational fluid dynamics analysis, the determining, and the updating of the value of the design parameter, until the analysis result in the performing of the computational fluid dynamics analysis is determined by the determining as satisfying the design condition.

An aspect of the technology provides an intake duct designing apparatus. The apparatus includes: a parameter setting unit that sets a value of a design parameter concerning a design target on a basis of an input operation, in which the design target is directed to an intake duct of an aircraft and in which the intake duct includes a bypass mechanism that suppresses an aerial vibration phenomenon; a shape setting unit that sets a shape of the design target on the basis of the value of the design parameter; a computational fluid dynamics analyzer that performs computational fluid dynamics analysis that includes calculating an aerodynamic characteristic of the design target and a necessary bypassing flow rate of air to be released through the bypass mechanism that suppresses the aerial vibration phenomenon, by creating an analytical model for the computational fluid dynamics analysis on the basis of the shape of the design target set by the shape setting unit; a determining unit that determines whether an analysis result obtained by the computational fluid dynamics analyzer satisfies a preset design condition; and a design parameter updater that updates the value of the design parameter in a case where the analysis result obtained by the computational fluid dynamics analyzer is determined by the determining unit as not satisfying the design condition. The shape setting unit, the computational fluid dynamics analyzer, the determining unit, and the design parameter updater repeats their respective processings, until the analysis result obtained by the computational fluid dynamics analyzer is determined by the determining unit as satisfying the design condition.

An aspect of the technology provides an intake duct designing apparatus. The apparatus includes circuitry configured to set a value of a design parameter concerning a design target on a basis of an input operation, in which the design target is directed to an intake duct of an aircraft and in which the intake duct includes a bypass mechanism that suppresses an aerial vibration phenomenon; set a shape of the design target on the basis of the value of the design parameter; perform computational fluid dynamics analysis that includes calculating an aerodynamic characteristic of the design target and a necessary bypassing flow rate of air to be released through the bypass mechanism that suppresses the aerial vibration phenomenon, by creating an analytical model for the computational fluid dynamics analysis on the basis of the shape of the set design target; determine whether an analysis result satisfies a preset design condition; update the value of the design parameter in a case where the analysis result is determined as not satisfying the design condition; and repeat processings of the setting of the shape, the performing of the computational fluid dynamics analysis, the determining, and the updating of the value of the design parameter, until the analysis result is determined as satisfying the design condition.

### BRIEF DESCRIPTION OF THE DRAWINGS

FIG. 1 is a block diagram illustrating an example of a configuration of an intake duct designing apparatus according to one example embodiment of the technology.

FIG. 2 describes an example of a design target in an intake duct designing processing.

FIG. 3 is a flowchart illustrating an example of a flow of the intake duct designing processing.

### DETAILED DESCRIPTION

In the following, some embodiments of the technology are described with reference to the accompanying drawings. Note that the following description is directed to illustrative examples of the disclosure and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description.

Existing designing methods have involved performing a wind tunnel test to know a bypassing flow rate of air that allows for suppression of buzz. This makes it difficult to secure sufficient number of times of a designing cycle due to issues of cost and time, thus making it difficult to obtain an optimum shape of an intake duct.

It is desirable to allow for favorable designing of a shape of an intake duct having a bypass mechanism.

### [Configuration of Intake Duct Designing Apparatus]

Description is first given of a configuration of an intake duct designing apparatus 1. In one embodiment, the intake duct designing apparatus 1 may serve as an “intake duct designing apparatus”.

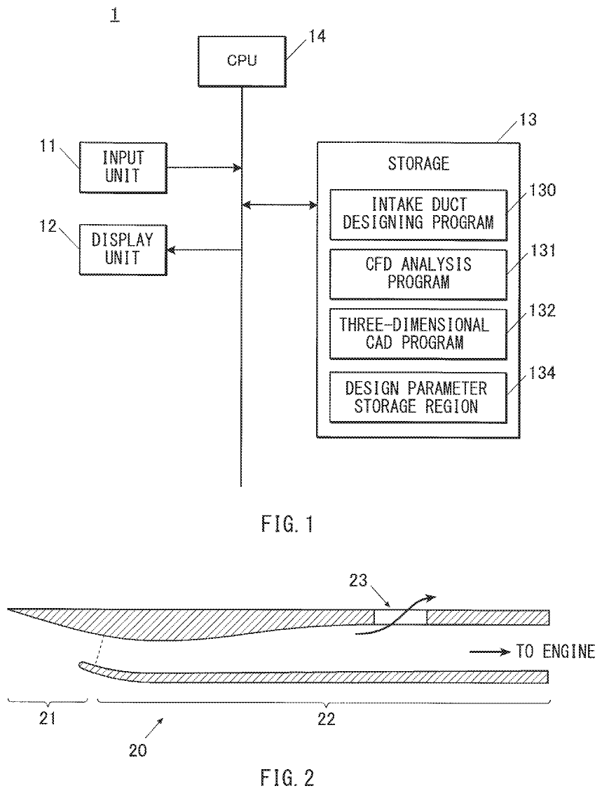

FIG. 1 is a block diagram illustrating a configuration of the intake duct designing apparatus 1.

In an example embodiment of the technology, the intake duct designing apparatus 1 may be an information processor that sets a shape of the intake duct of an aircraft. For example, the intake duct designing apparatus 1 may design the intake duct having the bypass mechanism. The intake duct having the bypass mechanism is described later with reference to FIG. 2. The bypass mechanism suppresses an aerial vibration phenomenon, i.e., buzz that occurs at supersonic flight.

In a specific but non-limiting example, the intake duct designing apparatus 1 may include an input unit 11, a display unit 12, a storage 13, and a central processing unit (CPU) 14, as illustrated in FIG. 1.

The input unit 11 may include various unillustrated input buttons. The input unit 11 may output to the CPU 14 an input signal corresponding to a position of a pressed button.

The display unit 12 may include an unillustrated display. The display unit 12 may display on the display various pieces of information on the basis of a display signal inputted from the CPU 14.

The storage 13 may be a memory including a random access memory (RAM) and a read only memory (ROM). The storage 13 may store various programs and data, and may also serve as a work area of the CPU 14. In one example embodiment, the storage 13 may store an intake duct designing program 130, a computational fluid dynamics (CFD) analysis program 131, and a three-dimensional CAD program 132.

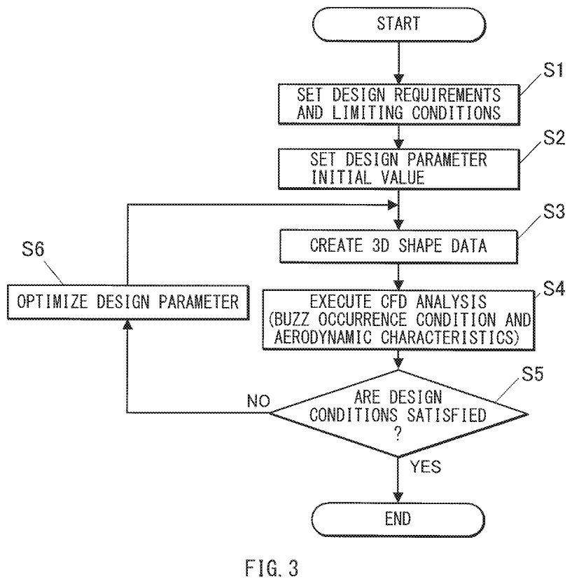

The intake duct designing program 130 may cause the CPU 14 to execute an intake duct designing processing described later. Reference is made to FIG. 3 for the intake duct designing processing.

The CFD analysis program 131 may be CFD analysis software that calculates factors such as aerodynamic characteristics of a design target.

The three-dimensional CAD program 132 may be software that creates an analytical model for the CFD analysis program 131.

The storage 13 may include a design parameter storage region 134. The design parameter storage region 134 may be a memory region that stores a design parameter in the intake duct designing processing described later.

The CPU 14 may execute a processing based on a predetermined program in response to an inputted instruction and may perform operations such as giving an instruction and data transfer to each of operational units to thereby integrally control the intake duct designing apparatus 1. In a specific but non-limiting example, the CPU 14 may read out various programs from the storage 13 in response to a signal such as an operation signal inputted from the input unit 11 to thereby execute a processing in accordance with the various programs. Thereafter, the CPU 14 may cause the storage 13 to temporarily hold a result of the processing, and may output the result of the processing to the display unit 12 on an as-needed basis.

### [Operation of Intake Duct Designing Apparatus]

Description is give next of an operation of the intake duct designing apparatus 1 upon executing the intake duct designing processing.

FIG. 2 schematically illustrates the intake duct that is a design target of the intake duct designing processing. FIG. 3 is a flowchart illustrating a flow of the intake duct designing processing.

Referring to FIG. 2, the intake duct designing processing is directed to designing a shape of an intake duct 20 of an aircraft in consideration mainly of aerodynamic characteristics. In a specific but non-limiting example, the design target, i.e., a design range of the intake duct designing processing may be directed to a shape of the entire intake duct 20 including an intake 21 and a duct part 22. The intake 21 may be located at a port of the duct. The duct part 22 may extend from the intake 21 to a port of the engine. The duct part 22 may include a bypass mechanism 23 that suppresses the aerial vibration phenomenon, i.e., the buzz at the supersonic flight. The buzz occurs when a flow rate of air falls below a predetermined value. Hence, it is possible to favorably suppress the buzz by taking in air having a flow rate enough to suppress the buzz and by releasing air that is unnecessary in amount for the engine, among the air that has been taken in. The air unnecessary in amount for the engine is released out of the duct through the bypass mechanism 23. In other words, the air unnecessary in amount for the engine is bypassed out of the duct.

The intake duct designing processing may be executed by causing the CPU 14 to read out the intake duct designing program 130 from the storage 13 and to expand the read-out program when a user inputs an instruction to execute the intake duct designing processing.

Upon setting a shape of each of the parts in the intake duct designing processing, the three-dimensional CAD program 132 may be used to set a three-dimensional shape of each of the parts. At this occasion, a non-uniform rational basis spline (NURBS) mathematical function, for example, may be used to create shapes of a curve and a curved surface of a connection surface, for example, of each of the parts.

Referring to FIG. 3, when the intake duct designing processing is executed, the CPU 14 may first set various design requirements and limiting conditions on the basis of an operation of a user (step S1). The various design requirements may concern the design target. Non-limiting example of the limiting conditions may include layout of equipment.

The CPU 14 may thereafter set an initial value of a design parameter on the basis of an operation of the user (step S2).

In a specific but non-limiting example, the step S2 may involve appropriately setting an initial value of a parameter such as a shape parameter of the intake duct 20 by taking account of the design requirements and the limiting conditions that have been set in step S1.

Thereafter, the CPU 14 may receive the initial value of the design parameter inputted by the user to thereby cause the design parameter storage region 134 to store the initial value.

The CPU 14 may thereafter create 3D shape data of the intake duct 20 on the basis of the three-dimensional CAD program 132 (step S3).

In this example, shapes of the intake 21, the duct part 22, and the bypass mechanism 23 may be designed, for example, on the basis of the design parameter set in step S2.

The CPU 14 may thereafter execute CFD analysis using the 3D shape data created in step S3 (step S4).

In a more specific but non-limiting example, the CPU 14 may create an analytical grid for the 3D shape data on the basis of the CFD analysis program 131 to thereby create a CFD analytical model and to execute the CFD analysis thereafter. The CFD analysis may involve, for example, executing analysis for a design point based on a supersonic region and executing analysis for an off-design point based on a subsonic region.

In the example embodiment, buzz occurrence condition, i.e., a necessary bypassing flow rate as well as comprehensive aerodynamic characteristics such as total pressure loss and distortion may be calculated by the CFD analysis.

The CPU 14 may thereafter determine whether an analysis result obtained from the CDF analysis of step S4 satisfies predetermined design conditions (step S5).

In this example, the design conditions may be preset in terms of each of the design point and the off-design point for the analysis result obtained from the CDF analysis.

In a case where determination is made that the analysis result obtained from the CDF analysis does not satisfy any of the design conditions in this step S5 (step S5: NO), the CPU 14 may update the design parameter stored in the design parameter storage region 134 while optimizing the stored design parameter (step S6). The processing may thereby proceed to step S3 described above.

At this occasion, the CPU 14 may so optimize the design parameter as to allow the analysis result obtained from the CDF analysis to satisfy the design condition. For example, an optimization method such as a gradient method, genetic algorithm, or response surface methodology may be used to thereby update the design parameter while performing optimization, in order to obtain a solution that satisfies the design condition.

Accordingly, the creation of the shape data of the design target, the CFD analysis, the determination on whether any of the design conditions is satisfied, and the optimization, i.e., the updating of the design parameter are repeated, until the result obtained from the CDF analysis satisfies the design condition.

In a case where determination is made that the analysis result obtained from the CDF analysis satisfies the design conditions in step S5 (step S5: YES), the CPU 14 may, for example, output a result of the processing to the display unit 12 and may thereafter end the intake duct designing processing.

### [Effects]

As described above, according to the present example embodiment, the design target is directed to the intake duct 20 having the bypass mechanism 23. Further, the aerodynamic characteristics of the design target and the necessary bypassing flow rate of air to be released through the bypass mechanism 23 that suppresses the aerial vibration phenomenon are calculated by means of the CFD analysis. The CFD analysis may be repeated while updating the design parameter concerning the design target as needed until the analysis result obtained from the CDF analysis satisfies the predetermined design conditions.

This allows for determination of the necessary bypassing flow rate of air, i.e., the buzz occurrence condition by means of the CFD analysis without depending on the wind tunnel test. This makes it possible to save cost and time required for one designing cycle as well as to automate processes from the setting, i.e., updating of the design parameter to evaluation of performance. Accordingly, it is possible to secure the number of times of the designing cycle as well as to obtain an optimum shape of the intake duct 20.

Hence, it becomes possible to favorably design the shape of the intake duct 20 having the bypass mechanism 23.

Moreover, upon the updating of the design parameter, the design parameter may be updated while being optimized, in order to obtain a solution that satisfies the design conditions. This makes it possible to obtain an optimum shape of the intake duct 20 more favorably.

Note that an example embodiment to which the technology is applicable is not limited to the foregoing example embodiment, and may be modified appropriately without departing from the scope of the technology.

The CPU 14 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the CPU 14. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the CPU 14 illustrated in FIG. 1.

1. An intake duct designing method that uses an intake duct designing apparatus, the method comprising:
setting a value of a design parameter concerning a design target on a basis of an input operation, the design target being directed to an intake duct of an aircraft, the intake duct including a bypass mechanism that suppresses an aerial vibration phenomenon;
setting a shape of the design target on a basis of the value of the design parameter;
performing computational fluid dynamics analysis, the performing of the computational fluid dynamics analysis including calculating an aerodynamic characteristic of the design target and a necessary bypassing flow rate of air by creating an analytical model for the computational fluid dynamics analysis on a basis of the shape of the design target set in the setting of the shape, the air being released through the bypass mechanism that suppresses the aerial vibration phenomenon;
determining whether an analysis result in the performing of the computational fluid dynamics analysis satisfies a preset design condition;
updating the value of the design parameter in a case where the analysis result in the performing of the computational fluid dynamics analysis is determined by the determining as not satisfying the design condition; and
repeating the setting of the shape, the performing of the computational fluid dynamics analysis, the determining, and the updating of the value of the design parameter, until the analysis result in the performing of the computational fluid dynamics analysis is determined by the determining as satisfying the design condition.

2. The intake duct designing method according to claim 1, wherein the updating of the value of the design parameter includes optimizing the design parameter to thereby obtain a solution that satisfies the design condition.

3. The intake duct designing method according to claim 1, wherein the performing of the computational fluid dynamics analysis includes executing a calculation for each of a design point in a case where the aircraft has a speed that is in a supersonic range and an off-design point in a case where the aircraft has a speed that is lower than the speed related to the design point.

4. The intake duct designing method according to claim 2, wherein the performing of the computational fluid dynamics analysis includes executing a calculation for each of a design point in a case where the aircraft has a speed that is in a supersonic range and an off-design point in a case where the aircraft has a speed that is lower than the speed related to the design point.

5. A non-transitory computer readable medium containing an intake duct designing program, the intake duct designing program causing, when executed by a computer, the computer to implement a method, the method comprising:
setting a value of a design parameter concerning a design target on a basis of an input operation, the design target being directed to an intake duct of an aircraft, the intake duct including a bypass mechanism that suppresses an aerial vibration phenomenon;
setting a shape of the design target on a basis of the value of the design parameter;
performing computational fluid dynamics analysis, the performing of the computational fluid dynamics analysis including calculating an aerodynamic characteristic of the design target and a necessary bypassing flow rate of air by creating an analytical model for the computational fluid dynamics analysis on a basis of the shape of the design target set in the setting of the shape, the air being released through the bypass mechanism that suppresses the aerial vibration phenomenon;
determining whether an analysis result in the performing of the computational fluid dynamics analysis satisfies a preset design condition;
updating the value of the design parameter in a case where the analysis result in the performing of the computational fluid dynamics analysis is determined by the determining as not satisfying the design condition; and
repeating the setting of the shape, the performing of the computational fluid dynamics analysis, the determining, and the updating of the value of the design parameter, until the analysis result in the performing of the computational fluid dynamics analysis is determined by the determining as satisfying the design condition.

6. An intake duct designing apparatus comprising:
a parameter setting unit that sets a value of a design parameter concerning a design target on a basis of an input operation, the design target being directed to an intake duct of an aircraft, the intake duct including a bypass mechanism that suppresses an aerial vibration phenomenon;
a shape setting unit that sets a shape of the design target on a basis of the value of the design parameter;
a computational fluid dynamics analyzer that performs computational fluid dynamics analysis that includes calculating an aerodynamic characteristic of the design target and a necessary bypassing flow rate of air by creating an analytical model for the computational fluid dynamics analysis on a basis of the shape of the design target set by the shape setting unit, the air being released through the bypass mechanism that suppresses the aerial vibration phenomenon;
a determining unit that determines whether an analysis result obtained by the computational fluid dynamics analyzer satisfies a preset design condition; and
a design parameter updater that updates the value of the design parameter in a case where the analysis result obtained by the computational fluid dynamics analyzer is determined by the determining unit as not satisfying the design condition,
the shape setting unit, the computational fluid dynamics analyzer, the determining unit, and the design parameter updater repeating their respective processings, until the analysis result obtained by the computational fluid dynamics analyzer is determined by the determining unit as satisfying the design condition.

7. An intake duct designing apparatus, the apparatus comprising circuitry configured to
set a value of a design parameter concerning a design target on a basis of an input operation, the design target being directed to an intake duct of an aircraft, the intake duct including a bypass mechanism that suppresses an aerial vibration phenomenon,
set a shape of the design target on a basis of the value of the design parameter,
perform computational fluid dynamics analysis that includes calculating an aerodynamic characteristic of the design target and a necessary bypassing flow rate of air by creating an analytical model for the computational fluid dynamics analysis on a basis of the shape of the set design target, the air being released through the bypass mechanism that suppresses the aerial vibration phenomenon,
determine whether an analysis result satisfies a preset design condition,
update the value of the design parameter in a case where the analysis result is determined as not satisfying the design condition, and
repeat processings of the setting of the shape, the performing of the computational fluid dynamics analysis, the determining, and the updating of the value of the design parameter, until the analysis result is determined as satisfying the design condition.
